(19) United States
(12) Patent Application Publication
(10) Pub. No.: US 2020/0365222 A1
(43) Pub. Date: Nov. 19, 2020

(54) PHYSICALLY UNCLONABLE FUNCTION (PUF) IN PROGRAMMABLE READ-ONLY MEMORY (PROM)

(71) Applicant: QUALCOMM Incorporated, San Diego, CA (US)

(72) Inventors: Hochul LEE, Los Angeles, CA (US); Keejong KIM, Phoenix, AZ (US); Anil Chowdary KOTA, San Diego, CA (US); Chulmin JUNG, San Diego, CA (US)

(21) Appl. No.: 16/411,316

(22) Filed: May 14, 2019

(51) Int. Cl. G11C 17/18; G11C 17/16; G06F 1/06; H04L 9/32

(52) U.S. Cl. CPC G11C 17/18; G11C 17/16; H03K 19/20; H04L 9/3278; G06F 1/06

(57) ABSTRACT

Certain aspects of the present disclosure provide apparatus and techniques for random bit generation. One example apparatus generally includes a switch, a fuse coupled to the switch, a driver circuit having an output coupled to the fuse, an amplifier having an input coupled to the driver circuit, and a counter coupled to an output of the amplifier.

### FIELD OF THE DISCLOSURE

The teachings of the present disclosure relate generally to electronic systems, and more particularly, to apparatus and techniques for random bit generation.

### DESCRIPTION OF RELATED ART

Electronic devices including processors and memory are used extensively today in almost every electronic application. The processor controls the execution of program instructions, arithmetic functions, and access to memory and peripherals. In the simplest form, the processor executes program instructions by performing one or more arithmetic functions on data stored in memory.

Techniques that provide secure product identification are important for the authentication of electronic devices. One example technique may involve a physically unclonable function (PUF) that generates a digital fingerprint for electronic devices using naturally occurring physical variations between the electronic devices.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Certain aspects of the present disclosure are generally directed to circuitry for random bit generation to facilitate authentication of electronic products using a physically unclonable function (PUF).

Certain aspects are directed to an apparatus for random bit generation. The apparatus generally includes a switch, a fuse coupled to the switch, a driver circuit having an output coupled to the fuse, an amplifier having an input coupled to the driver circuit, and a counter coupled to an output of the amplifier.

Certain aspects are directed to an apparatus for random bit generation. The apparatus generally includes a plurality of memory cells, each of the memory cells comprising a switch, and a fuse coupled to the switch. The apparatus may also include random bit generation circuitry coupled to the plurality of memory cells, the random bit generation circuitry comprising a driver circuit having an output coupled to the fuse, an amplifier having an input coupled to the driver circuit, and a counter coupled to an output of the amplifier.

Certain aspects are directed to a method for random bit generation. The method generally includes driving a current across a fuse, determining a time period from when the current is driven across the fuse until the fuse blows, and generating a signal based on the determination.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is an illustration of an exemplary system-on-chip (SoC) integrated circuit design, in accordance with certain aspects of the present disclosure.

FIG. 2 illustrates a challenge-response authentication process between an authentication server and an electronic device.

FIG. 3 illustrates a memory cell of a read-only memory (ROM), in accordance with certain aspects of the present disclosure.

FIG. 4 is a graph illustrating blowing times of fuses of memory cells.

FIG. 5 illustrates a memory cell and physical unclonable function (PUF) circuitry for random bit generation, in accordance with certain aspects of the present disclosure.

FIG. 6 illustrates the PUF circuitry of FIG. 5 after a fuse of the memory cell blows, in accordance with certain aspects of the present disclosure.

FIG. 7 is a flow diagram illustrating example operations for random bit generation, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the disclosure or the claims.

The terms “computing device” and “mobile device” are used interchangeably herein to refer to any one or all of servers, personal computers, smartphones, cellular telephones, tablet computers, laptop computers, netbooks, ultrabooks, palm-top computers, personal data assistants (PDAs), wireless electronic mail receivers, multimedia Internet-enabled cellular telephones, Global Positioning System (GPS) receivers, wireless gaming controllers, and similar personal electronic devices which include a programmable processor. While the various aspects are particularly useful in mobile devices (e.g., smartphones, laptop computers, etc.), which have limited resources (e.g., processing power, battery, size, etc.), the aspects are generally useful in any computing device that may benefit from improved processor performance and reduced energy consumption.

The term “multicore processor” is used herein to refer to a single integrated circuit (IC) chip or chip package that contains two or more independent processing units or cores (e.g., CPU cores, etc.) configured to read and execute program instructions. The term “multiprocessor” is used herein to refer to a system or device that includes two or more processing units configured to read and execute program instructions.

The term “system on chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors (DSPs), modem processors, video processors, etc.), memory blocks (e.g., ROM, RAM, flash, etc.), and resources (e.g., timers, voltage regulators, oscillators, etc.), any or all of which may be included in one or more cores.

A number of different types of memories and memory technologies are available or contemplated in the future, all of which are suitable for use with the various aspects of the present disclosure. Such memory technologies/types include dynamic random-access memory (DRAM), static random-access memory (SRAM), non-volatile random-access memory (NVRAM), flash memory (e.g., embedded multimedia card (eMMC) flash), pseudostatic random-access memory (PSRAM), double data rate synchronous dynamic random-access memory (DDR SDRAM), and other random-access memory (RAM) and read-only memory (ROM) technologies known in the art. A DDR SDRAM memory may be a DDR type 1 SDRAM memory, DDR type 2 SDRAM memory, DDR type 3 SDRAM memory, or a DDR type 4 SDRAM memory. Each of the above-mentioned memory technologies includes, for example, elements suitable for storing instructions, programs, control signals, and/or data for use in or by a computer or other digital electronic device. Any references to terminology and/or technical details related to an individual type of memory, interface, standard, or memory technology are for illustrative purposes only, and not intended to limit the scope of the claims to a particular memory system or technology unless specifically recited in the claim language. Mobile computing device architectures have grown in complexity, and now commonly include multiple processor cores, SoCs, co-processors, functional modules including dedicated processors (e.g., communication modem chips, GPS receivers, etc.), complex memory systems, intricate electrical interconnections (e.g., buses and/or fabrics), and numerous other resources that execute complex and power intensive software applications (e.g., video streaming applications, etc.).

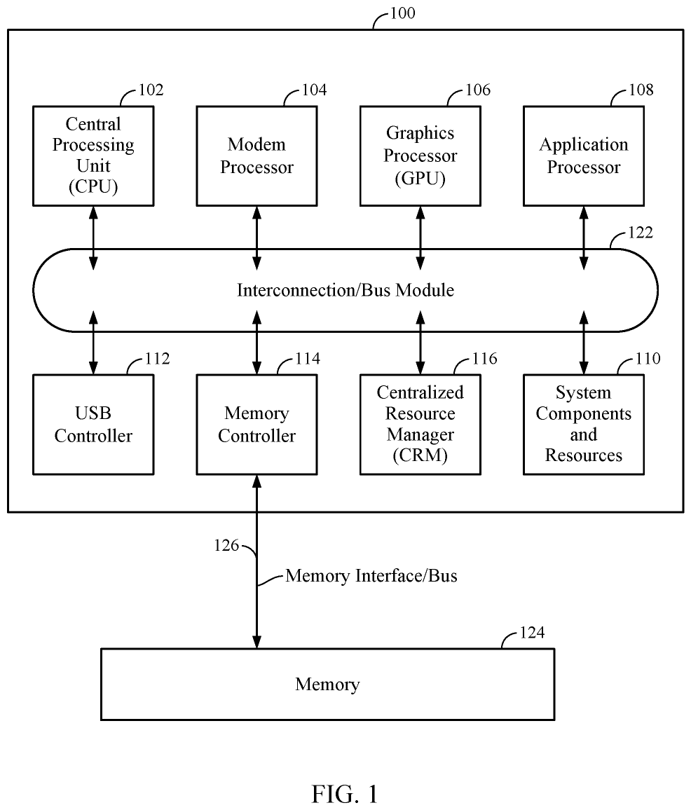

FIG. 1 illustrates example components and interconnections in a system-on-chip (SoC) 100 suitable for implementing various aspects of the present disclosure. The SoC 100 may include a number of heterogeneous processors, such as a central processing unit (CPU) 102, a modem processor 104, a graphics processor 106, and an application processor 108. Each processor 102, 104, 106, 108, may include one or more cores, and each processor/core may perform operations independent of the other processors/cores. The processors 102, 104, 106, 108 may be organized in close proximity to one another (e.g., on a single substrate, die, integrated chip, etc.) so that the processors may operate at a much higher frequency/clock rate than would be possible if the signals were to travel off-chip. The proximity of the cores may also allow for the sharing of on-chip memory and resources (e.g., voltage rails), as well as for more coordinated cooperation between cores.

The SoC 100 may include system components and resources 110 for managing sensor data, analog-to-digital conversions, and/or wireless data transmissions, and for performing other specialized operations (e.g., decoding high-definition video, video processing, etc.). System components and resources 110 may also include components such as voltage regulators, oscillators, phase-locked loops (PLLs), peripheral bridges, data controllers, system controllers, access ports, timers, and/or other similar components used to support the processors and software clients running on the computing device. The system components and resources 110 may also include circuitry for interfacing with peripheral devices, such as cameras, electronic displays, wireless communication devices, external memory chips, etc.

The SoC 100 may further include a Universal Serial Bus (USB) controller 112, one or more memory controllers 114, and a centralized resource manager (CRM) 116. The SoC 100 may also include an input/output module (not illustrated) for communicating with resources external to the SoC, each of which may be shared by two or more of the internal SoC components.

The processors 102, 104, 106, 108 may be interconnected to the USB controller 112, the memory controller 114, system components and resources 110, CRM 116, and/or other system components via an interconnection/bus module 122, which may include an array of reconfigurable logic gates and/or implement a bus architecture (e.g., CoreConnect, AMBA, etc.). Communications may also be provided by advanced interconnects, such as high performance networks on chip (NoCs).

The interconnection/bus module 122 may include or provide a bus mastering system configured to grant SoC components (e.g., processors, peripherals, etc.) exclusive control of the bus (e.g., to transfer data in burst mode, block transfer mode, etc.) for a set duration, number of operations, number of bytes, etc. In some cases, the interconnection/bus module 122 may implement an arbitration scheme to prevent multiple master components from attempting to drive the bus simultaneously.

The memory controller 114 may be a specialized hardware module configured to manage the flow of data to and from a memory 124 (e.g., a read-only memory (ROM)) via a memory interface/bus 126. Certain aspects of the present disclosure are generally directed to random bit generation using variation in physical characteristics of fuses that may be implemented in ROM, as described in more detail herein.

The memory controller 114 may comprise one or more processors configured to perform read and write operations with the memory 124. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In certain aspects, the memory 124 may be part of the SoC 100.

### Example Physically Unclonable Function (Puf) in Programmable Read-Only Memory (Prom)

A security protocol aimed at secure key storage and lightweight authentication, called “physically unclonable function (PUF),” has emerged in recent years. A PUF in an integrated circuit (IC) generates a digital fingerprint that serves as a unique identifier for an electronic device. PUFs generate unique identity codes based on physical variations that occur naturally during semiconductor manufacturing, as described in more detail herein.

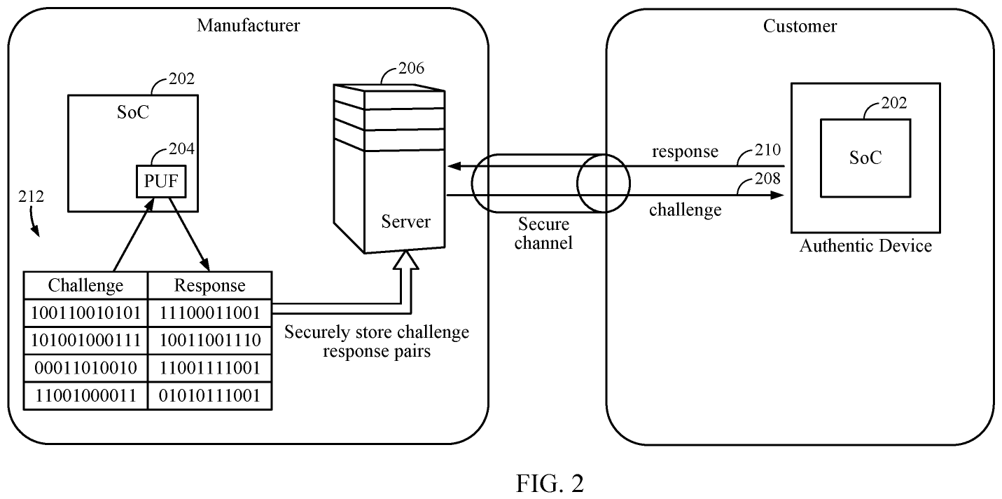

FIG. 2 illustrates a challenge-response authentication process between an authentication server 206 and an electronic device 202. As illustrated, during the manufacturing process, physical characteristics of the electronic device 202 are used to generate challenge-response value pairs via PUF circuitry 204 of the electronic device 202. The challenge-response value pairs are securely stored on the server 206.

When the server 206 seeks to authenticate the electronic device 202, the server 206 sends a challenge signal 208 to the electronic device 202, and the electronic device 202 provides a corresponding response signal 210. A response signal is unique for each electronic device and each challenge signal. The response signal 210 from the electronic device 202 is sent to the server 206 for authentication. The response signal 210 may be retrieved from a programmable read-only memory (PROM) of the electronic device 202. The server 206 may check that the response signal 210 corresponds to the challenge signal 208 for the electronic device 202 via a lookup table 212 stored on the server 206. If so, the electronic device 202 is considered to be an authentic device.

There are various techniques for generating the challenge-response value pairs. For example, variations in gate-oxide breakdown voltages of transistors may be unpredictable and used to generate random digital values to uniquely identify electronic devices. However, this technique involves using high voltage circuitry (e.g., a charge pump), causing area overhead and additional design effort. Certain aspects of the present disclosure are directed to using an electric fuse (eFuse) PROM, which is a one-time programmable (OTP) non-volatile memory, for random bit generation and to generate challenge-response pairs.

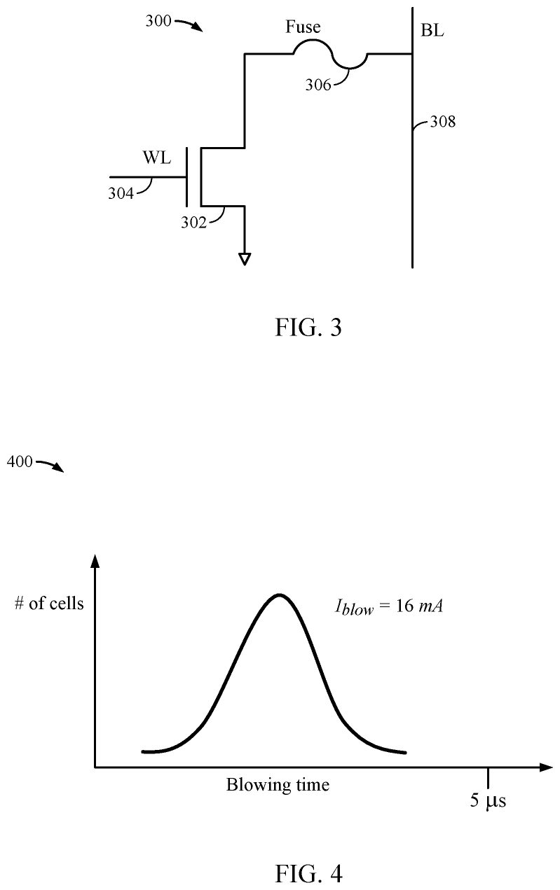

FIG. 3 illustrates a memory cell 300 of a ROM (e.g., memory 124), in accordance with certain aspects of the present disclosure. As illustrated, the memory cell 300 includes a fuse 306 coupled between the transistor 302 and the bit-line (BL) 308 of the ROM. During a write process, the fuse 306 may be blown to write a digital value to the memory cell. The gate of the transistor 302 is coupled to the word-line (WL) 304. A signal may be applied to each of the WL 304 and the BL 308 to drive high current through the fuse 306, creating a high resistance path through the fuse. During a read process, the high resistance path may be sensed to determine the digital value associated with the memory cell.

FIG. 4 is a graph 400 illustrating blowing times of fuses of memory cells. As illustrated, if a blowing current I_{blow} (e.g., 16 mA) is directed through fuses of multiple memory cells for less than a certain period (e.g., 5 μs) after which all the fuses would be expected to be blown for a given I_{blow}, the number of cell fuses that blow varies with the blow time. In other words, the exact blowing time of each cell is unpredictable due to process-dependent characteristics of each fuse. Certain aspects of the present disclosure use this unpredictable nature of the fuse blowing time for random bit generation for use as the PUF. For example, a blowing time of a memory cell fuse may be measured by using a digital counter. The least-significant bits (LSBs) of the counter for each blowing case may be different and random due to the unpredictable nature of the fuses, and may be used as a random value to generate unique response codes.

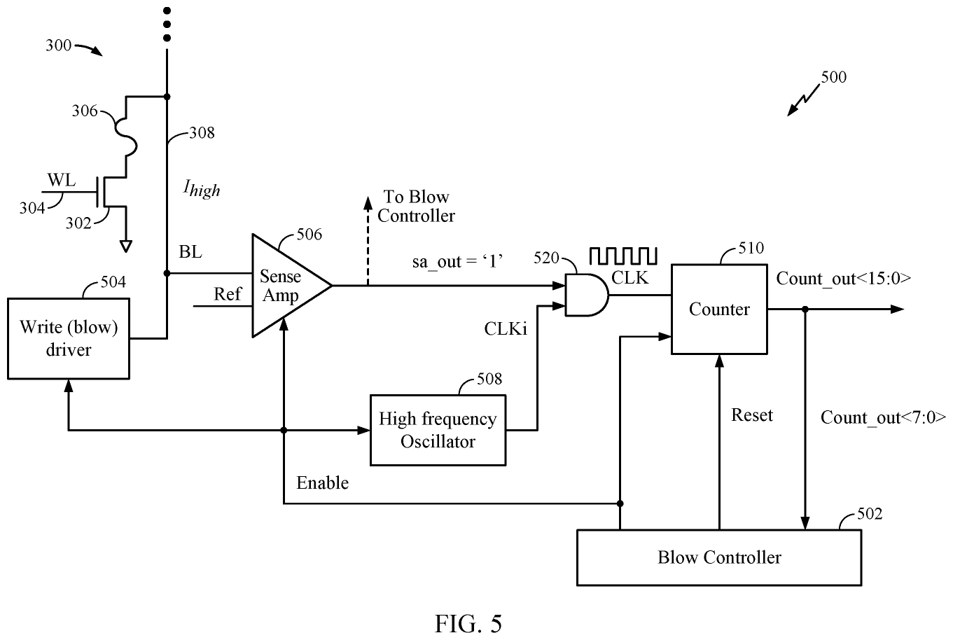

FIG. 5 illustrates a memory cell 300 and PUF circuitry 500 for random bit generation, in accordance with certain aspects of the present disclosure. The PUF circuitry 500 may, for example, be implemented in the memory controller 114 described with respect to FIG. 1.

As illustrated, the PUF circuitry 500 includes a blow controller 502 for controlling a write driver 504, sense amplifier 506, oscillator 508 (e.g., high frequency oscillator), and counter 510. For example, the blow controller 502 may reset the counter 510, after which the blow controller 502 may simultaneously enable the write driver 504, sense amplifier 506, oscillator 508, and counter 510. A row decoder (not shown) applies a control voltage via the WL 304 to the gate of the transistor 302 and the write driver 504 applies a signal to the BL 308 to drive high current (I_{high}) through the fuse 306. The sense amplifier 506 compares the voltage at the BL 308 with a reference voltage (Ref) and provides an output (sa_out) of logic high based on the comparison, prior to the fuse being blown.

The output of the sense amplifier 506 is applied to an input of an AND gate 520, the other input of the AND gate 520 being coupled to the output of the oscillator 508. Thus, the output of the AND gate 520 may be a clock (CLK) signal, corresponding to the input CLK signal (CLKi) generated by the oscillator 508, as long as the output of the sense amplifier is logic high. Therefore, the counter 510 increments the counter output (count_out) after each pulse of the CLK signal. In certain aspects, the counter output may be a 16-bit digital signal.

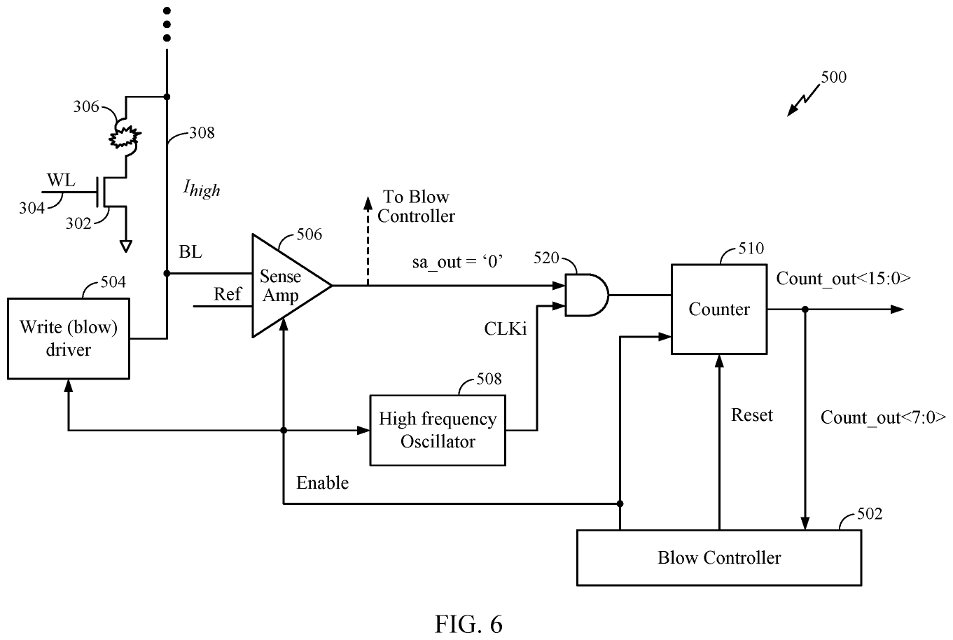

FIG. 6 illustrates the PUF circuitry 500 after the fuse 306 blows, in accordance with certain aspects of the present disclosure. As illustrated, once the fuse blows, a high resistance path is created through the fuse 306, and as a result, the amount of current being sunk by the transistor 302 decreases to a lower current (I_{low}). Thus, the voltage at the BL 308 increases above the reference voltage (Ref), resulting in the output (sa_out) of the sense amplifier 506 transitioning from logic high to logic low. Therefore, the output of the AND gate 520 no longer pulses according to the CLKi signal (i.e., the output is a constant logic low), and the counter 510 stops incrementing the counter output. At this point, the blow controller 502 may latch the counter output. In certain aspects, the blow controller 502 may latch the counter output based on an indication that the fuse 306 has blown. For example, the output signal generated by the sense amplifier 506 may be provided to the blow controller 502, with the transition from logic high to logic low in the output signal triggering the blow controller 502 to latch the counter output.

In certain aspects, the blow controller 502 may latch only a portion of the counter output (e.g., a number of least significant bits (e.g., 8 bits) of a 16-bit counter output). These LSBs are random due to the unpredictable nature of the fuse 306. In other aspects, all the bits of the counter output may be latched (e.g., the counter 510 is an 8-bit counter).

Since the blow time of the fuse 306 is unpredictable (e.g., random), the latched counter output is random and may be stored in memory as a response value corresponding to a specific challenge value. In other words, by blowing spare column cells of the ROM, random bits are generated and latched by the blow controller 502. Once a specific number (e.g., 64) of random values are generated, the random values are written in spare rows or main rows of the ROM via a conventional blowing (write) operation. Each of the random bits may be written to a different address in the ROM, each address corresponding to a challenge value. In other words, the address to which a response value is written corresponds to the challenge value associated with the response value to be used during the challenge-response authorization operations described with respect to FIG. 2.

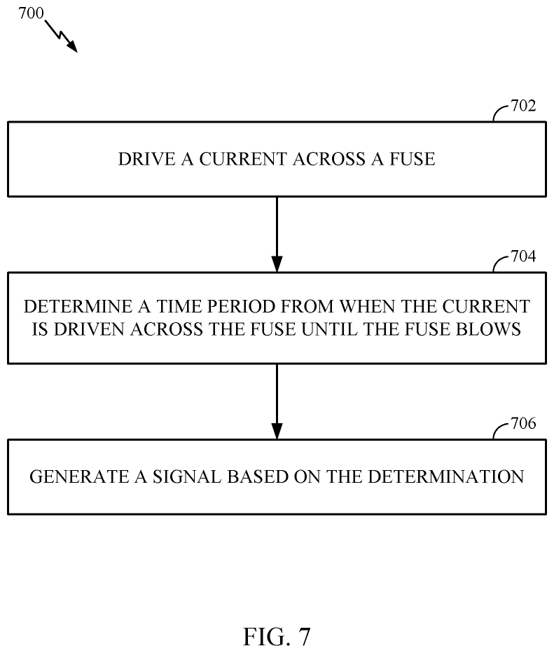

FIG. 7 is a flow diagram illustrating example operations 700 for random bit generation, in accordance with certain aspects of the present disclosure. The operations 700 may be performed by PUF circuitry, such as the PUF circuitry 500.

The operations 700 begin, at block 702, with the PUF circuitry driving (e.g., via write driver 504) a current across a fuse (e.g., fuse 306), and at block 704, the PUF circuitry determining a time period from when the current is driven across the fuse until the fuse blows. At block 706, the PUF circuitry generates (e.g., via counter 510) a signal based on the determination. In certain aspects, the signal comprises a digital signal, and generating the digital signal includes incrementing (e.g., via the counter 510) the digital signal from when the current is driven across the fuse until the fuse blows. The operations 700 may also include generating a clock signal (e.g., CLK signal at the output of AND gate 520) from when the current is driven across the fuse until the fuse blows, the digital signal being incremented based on each pulse of the clock signal.

In certain aspects, the current is driven across the fuse by generating a drive voltage, and determining the time period involves comparing (e.g., via sense amplifier 506) the drive voltage with a reference voltage, the signal being generated based on the comparison. In certain aspects, the signal is a digital signal, and the operations 700 also include latching and storing (e.g., via the blow controller 502) the digital signal after the fuse blows.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B and object B touches object C, then objects A and C may still be considered coupled to one another—even if objects A and C do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits.

The apparatus and methods described in the detailed description are illustrated in the accompanying drawings by various blocks, modules, components, circuits, steps, processes, algorithms, etc. (collectively referred to as “elements”). These elements may be implemented using hardware, for example.

One or more of the components, steps, features, and/or functions illustrated herein may be rearranged and/or combined into a single component, step, feature, or function or embodied in several components, steps, or functions. Additional elements, components, steps, and/or functions may also be added without departing from features disclosed herein. The apparatus, devices, and/or components illustrated herein may be configured to perform one or more of the methods, features, or steps described herein. The algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover at least: a, b, c, a-b, a-c, b-c, and a-b-c, as well as any combination with multiples of the same element (e.g., a-a, a-a-a, a-a-b, a-b-b, a-c-c, b-b, b-b-b, b-b-c, c-c, and c-c-c or any other ordering of a, b, and c). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

1. An apparatus for random bit generation, comprising:
a switch;
a fuse coupled to the switch, wherein the fuse is configured to have a resistance that increases when the fuse is blown;
a driver circuit having an output coupled to the fuse;
an amplifier having an input coupled to the driver circuit; and
a counter coupled to an output of the amplifier.

2. The apparatus of claim 1, further comprising an oscillator having an output coupled to an input of the counter.

3. The apparatus of claim 2, further comprising an AND gate having a first input coupled to the output of the amplifier, a second input coupled to the output of the oscillator, and an output coupled to the input of the counter.

4. The apparatus of claim 1, further comprising a controller coupled to the driver circuit and the counter.

5. The apparatus of claim 4, wherein the controller is further coupled to the output of the amplifier.

6. The apparatus of claim 4, further comprising an oscillator having an output coupled to an input of the counter, wherein the controller is configured to simultaneously enable the driver circuit and the oscillator.

7. The apparatus of claim 6, wherein:
the driver circuit is configured to drive a current across the fuse after the driver circuit is enabled;
the counter is configured to increment a digital signal from when the current is driven across the fuse until the fuse blows based on a clock signal generated by the oscillator after the oscillator is enabled; and
the controller is configured to latch the digital signal after the fuse blows.

8. The apparatus of claim 7, wherein the controller is configured to obtain an indication that the fuse blows and latch the digital signal based on the indication.

9. The apparatus of claim 1, wherein:
the driver circuit is configured to drive a current across the fuse; and
the counter is configured to increment a digital signal at the output of the counter from when the current is driven across the fuse until the fuse blows.

10. The apparatus of claim 9, wherein the amplifier is configured to compare an output voltage of the driver circuit with a reference voltage, the counter being configured to increment the digital signal until the fuse blows based on an output signal of the amplifier.

11. The apparatus of claim 9, further comprising a memory, at least a portion of the digital signal at the output of the counter being stored in the memory after the fuse blows.

12. The apparatus of claim 11, wherein only a portion of the digital signal is stored in the memory, the portion comprising least significant bits (LSBs) of the digital signal.

13. An apparatus for random bit generation, comprising:
a plurality of memory cells, each of the memory cells comprising:
a switch; and
a fuse coupled to the switch, wherein the fuse is configured to have a resistance that increases when the fuse is blown; and
random bit generation circuitry coupled to the plurality of memory cells, the random bit generation circuitry comprising:
a driver circuit having an output coupled to the fuse;
an amplifier having an input coupled to the driver circuit; and
a counter coupled to an output of the amplifier.

14. The apparatus of claim 13, wherein the random bit generation circuitry further comprises an oscillator having an output coupled to an input of the counter.

15. The apparatus of claim 14, wherein the random bit generation circuitry further comprises an AND gate having a first input coupled to the output of the amplifier, a second input coupled to the output of the oscillator, and an output coupled to the input of the counter.

16. A method for random bit generation, comprising:
driving a current across a fuse, wherein the fuse is configured to have a resistance that increases when the fuse is blown;
determining a time period from when the current is driven across the fuse until the fuse blows; and
generating a signal based on the determination.

17. The method of claim 16, wherein the signal comprises a digital signal, and wherein generating the digital signal comprises:
incrementing the digital signal from when the current is driven across the fuse until the fuse blows.

18. The method of claim 17, further comprising:
generating a clock signal from when the current is driven across the fuse until the fuse blows, the digital signal being incremented based on each pulse of the clock signal.

19. The method of claim 16, wherein:
the current is driven across the fuse by generating a drive voltage; and
determining the time period comprises comparing the drive voltage with a reference voltage, the signal being generated based on the comparison.

20. The method of claim 16, wherein the signal comprises a digital signal, the method further comprising latching and storing at least a portion of the digital signal after the fuse blows.
